(19) United States
(12) Patent Application Publication
(10) Pub. No.: US 2015/0334700 A1
(43) Pub. Date: Nov. 19, 2015

(54) HANDHELD DEVICE, BASE STATION AND TRANSMISSION CONTROL METHOD THEREOF

(71) Applicant: MEDIATEK INC., Hsinchu (TW)

(72) Inventor: Jeng-Yi Tsai, Hsinchu City (TW)

(21) Appl. No.: 14/715,656

(22) Filed: May 19, 2015

Related U.S. Application Data
(60) Provisional application No. 62/000,165, filed on May 19, 2014.

(51) Int. Cl. H04W 72/04; H04L 5/00; H04L 1/18

(52) U.S. Cl. CPC H04W 72/0413; H04L 1/1861; H04L 5/0092

(57) ABSTRACT

A handheld device, a base station and transmission control methods thereof are provided. The handheld device transmits an uplink signal to the base station. The uplink signal comprises an uplink dedicated physical data channel (UL DPDCH) including a first radio data frame, a second radio data frame, a third radio data frame and a fourth radio data frame within two transmission time intervals (TTIs). A first dedicated traffic channel (DTCH) information data and first two segments of a dedicated control channel (DCCH) information data are repeatedly carried in the first and second radio data frames, and a second DTCH information data and last two segments of the dedicated control channel (DCCH) information data are repeatedly carried in the third and fourth radio data frames.

This application claims the benefit of priority based on U.S. Provisional Application Ser. No. 62/000,165 filed on May 19, 2014, which is hereby incorporated by reference in its entirety.

### CROSS-REFERENCES TO RELATED APPLICATIONS

Not applicable.

### BACKGROUND OF THE INVENTION

1. Field of the Invention

The present invention relates to a handheld device, a base station and transmission control methods thereof. More particularly, the handheld device of the present invention transmits an uplink signal in which every two consecutive radio frames of an uplink dedicated physical data channel (UL DPDCH) repeatedly carry a dedicated traffic channel (DTCH) information data and a part of a dedicated control channel (DCCH) information data.

2. Descriptions of the Related Art

With the development of wireless communication technologies, wireless devices have been widely used. To satisfy users' overwhelming demands for communication, various telecommunication standards have been developed. Universal mobile telecommunications system frequency division duplex (UMTS-FDD) Release 99 system is a version of the third generation (3G) communication system. The UMTS-FDD Release 99 provides circuit-switched speech services in which a circuit-switched connection is established between a user device and a base station. User data and physical layer control information are carried on dedicated physical channels (DPCHs) of the uplink signal and the downlink signal, and the uplink signal and the downlink signal are respectively transmitted in different frequency bands at the same time.

FIG. 1 depicts the transmission architecture in the normal mode of the existing UMTS-FDD Release 99 system. Each dedicated traffic channel (DTCH) information data (i.e. the processed user data) is carried within two radio frames of an uplink dedicated physical data channel (UL DPDCH) and each dedicated control channel (DCCH) information data (e.g. the processed signaling information data) is carried within four radio frames of the UL DPDCH. Specifically, the two segments X1, X2 of a first DTCH information data are generated from a user data through several processes such as CRC attachment, tail bit attachment, coding, interleaving, radio frame segmentation and rate matching. Similarly, the two segments Y1, Y2 of a second DTCH information data are generated from a user data through the above processes, and the four segments C1, C2, C3, C4 of a DCCH information data are generated from a signaling information data through the above processes.

The segment X1 of the first DTCH information data and the segment C1 of the DCCH information data are carried in a first radio data frame of the DPDCH after further interleaving. Then, the segment X2 of the first DTCH information data and the segment C2 of the DCCH information data are carried in a second radio data frame of the DPDCH after further interleaving. Similarly, the segment Y1 of the second DTCH information data and the segment C3 of the DCCH information data are carried in a third data radio frame of the DPDCH after further interleaving. Afterwards, the segment Y2 of the second DTCH information data and the segment C4 of the DCCH information data are carried in a fourth radio data frame of the DPDCH after further interleaving.

In the above transmission architecture, it is hard for base station to successfully decode the DTCH information data and/or the DCCH information data earlier since the probability of successfully decoding the DTCH information data and the DCCH information data is proportional to the received amount thereof. As a result, the uplink radio frame early termination is almost unachievable under the current transmission architecture of the UMTS-FDD Release 99 system.

Accordingly, an urgent need exists in the art to provide a transmission architecture which makes early decoding of the DTCH information data and the DCCH information data by the base station possible so as to achieve the uplink radio frame early termination.

### SUMMARY OF THE INVENTION

The objective of the present invention is to provide a transmission architecture in which DTCH information data and a part of the DCCH information data are repeatedly carried in two consecutive radio frames of UL DPDCH within two radio frames so that the base station may successfully decode the DTCH information data and the DCCH information data earlier and transmit an acknowledgement comment (ACK commend) to inform the user device of the decoding results. As a result, in the transmission architecture of the present invention, the uplink radio frame early termination is achievable so as to reduce the power consumption and the signal interference on both the user device and the base station and increase the overall system performance.

To achieve the aforesaid objective, the present invention discloses a handheld device which comprises a processor and a transceiver. The processor is configured to generate an uplink signal. The transceiver is electrically connected to the processor and configured to transmit the uplink signal to a base station. The uplink signal comprises an uplink dedicated physical data channel (UL DPDCH) including a first radio data frame, a second radio data frame, a third radio data frame and a fourth radio data frame within two transmission time intervals (TTIs). A first dedicated traffic channel (DTCH) information data and first two segments of a dedicated control channel (DCCH) information data are repeatedly carried in the first and second radio data frames, and a second DTCH information data and last two segments of the DCCH information data are repeatedly carried in the third and fourth radio data frames.

In addition, the present invention further discloses a transmission control method for use in a handheld device. The handheld device comprises a processor and a transceiver. The transceiver is electrically connected to the processor. The transmission control method comprises the following steps: generating, by the processor, an uplink signal; and transmitting, by the transceiver, the uplink signal to a base station. The uplink signal comprises an uplink dedicated physical data channel (UL DPDCH) including a first radio data frame, a second radio data frame, a third radio data frame and a fourth radio data frame within two transmission time intervals (TTIs). A first dedicated traffic channel (DTCH) information data and first two segments of a dedicated control channel (DCCH) information data are repeatedly carried in the first and second radio data frames, and a second DTCH information data and last two segments of the DCCH information data are repeatedly carried in the third and fourth radio data frames.

To achieve the aforesaid objective, the present invention further discloses a base station which comprises a transceiver and a processor. The transceiver is configured to receive an uplink signal from a handheld device. The uplink signal comprises an uplink dedicated physical data channel (UL DPDCH) including a first radio data frame, a second radio data frame, a third radio data frame and a fourth radio data frame within two transmission time intervals (TTIs). A first dedicated traffic channel (DTCH) information data and first two segments of a dedicated control channel (DCCH) information data are repeatedly carried in the first and second radio data frames, and a second DTCH information data and last two segments of the DCCH information data are repeatedly carried in the third and fourth radio data frames. The processor is electrically connected to the transceiver and configured to process the uplink signal.

Moreover, the present invention further discloses a transmission control method for use in a base station. The base station comprises a processor and a transceiver. The transceiver is electrically connected to the processor. The transmission control method comprises the following steps: receiving, by the transceiver, an uplink signal from a handheld device, wherein the uplink signal comprises an uplink dedicated physical data channel (UL DPDCH) including a first radio data frame, a second radio data frame, a third radio data frame and a fourth radio data frame within two transmission time intervals (TTIs), a first dedicated traffic channel (DTCH) information data and first two segments of a dedicated control channel (DCCH) information data are repeatedly carried in the first and second radio data frames, and a second DTCH information data and last two segments of the DCCH information data are repeatedly carried in the third and fourth radio data frames; and processing, by the processor, the uplink signal.

The detailed technology and preferred embodiments implemented for the subject invention are described in the following paragraphs accompanying the appended drawings for people skilled in this field to well appreciate the features of the claimed invention.

### BRIEF DESCRIPTION OF THE DRAWINGS

FIG. 1 is a schematic diagram showing how DTCH information data and DCCH information data are carried in radio data frames of the UL DPDCH in the conventional UMTS-FDD Release 99 system;

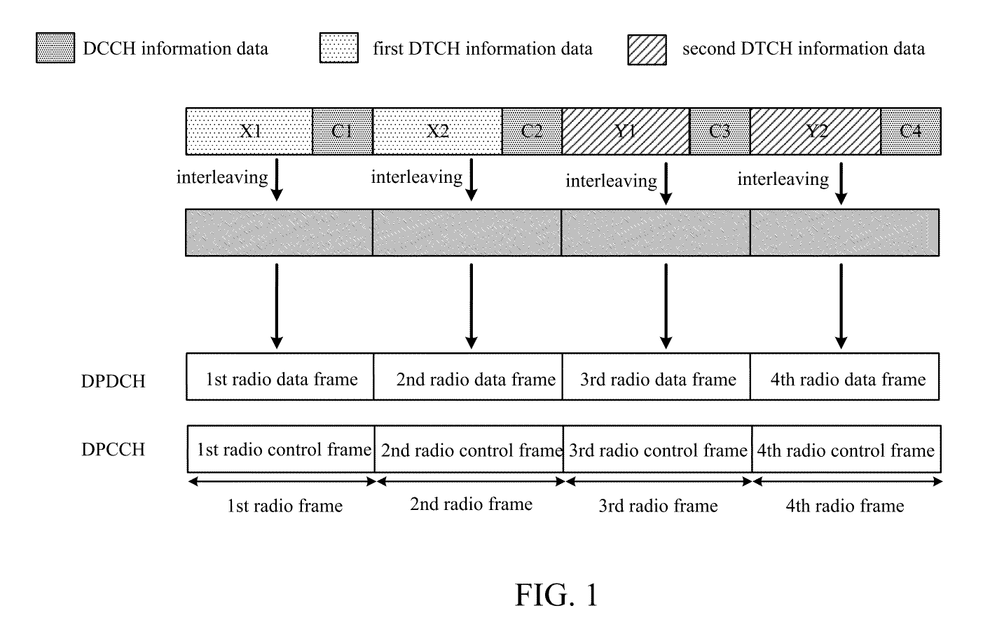

FIG. 2 is a schematic view of a handheld device 2 according to the first embodiment to the fifth embodiment of the present invention;

FIG. 3 is a schematic diagram showing how DTCH information data and DCCH information data are carried in radio data frames of the UL DPDCH in accordance with the present invention;

FIG. 4 is a schematic view of a base station 4 according to the first embodiment to the fifth embodiment of the present invention;

FIG. 5 is a flowchart diagram of a transmission control method according to the sixth embodiment of the present invention; and

FIG. 6 is a flowchart diagram of a transmission control method according to the seventh embodiment of the present invention.

### DESCRIPTION OF THE PREFERRED EMBODIMENT

The present invention provides a handheld device, a base station and transmission control methods thereof. In the following description, the present invention will be explained with reference to embodiments thereof. It shall be appreciated that theses embodiments of the present invention are not intended to limit the present invention to any specific environment, applications or implementations described in these embodiments. Therefore, the description of these embodiments is only for purpose of illustration rather than to limit the present invention and the scope claimed in this application shall be governed by the claims. Additionally, in the following embodiments and the attached drawings, elements unrelated to the present invention are omitted from depiction; and dimensional relationships among individual elements in the attached drawings are illustrated only for ease of understanding, but not to limit the actual scale.

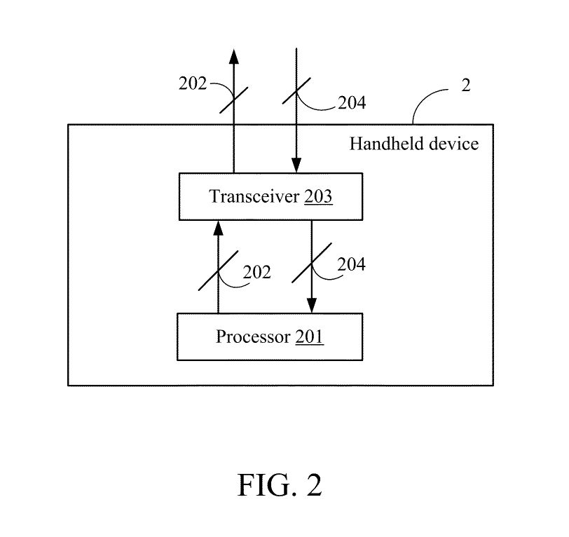

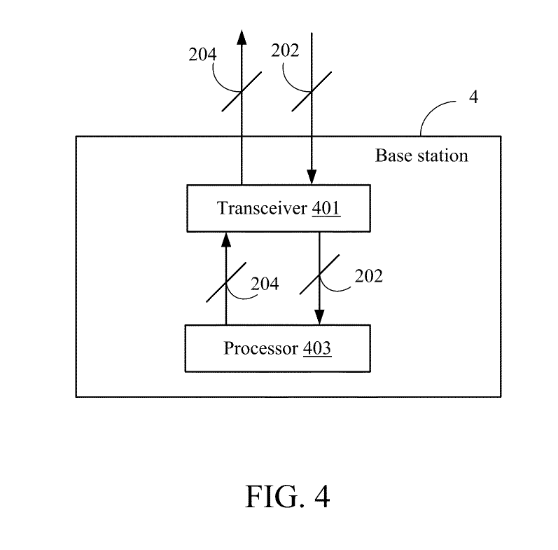

The first embodiment of the present invention is depicted in FIGS. 2-4. FIG. 2 is a schematic diagram of a handheld device 2. The handheld device 2 communicates with a base station 4 as shown in FIG. 4. The handheld device 2 and the base station 4 are designed for a UMTS-FDD like system which may be modified from the UMTS-FDD Release 99 system. The handheld device 2 may be a smart phone, a tablet computer, or any other device with communication capability. It shall be noted that for the purpose of simplicity, other elements of the handheld device 2, such as a display module, an antenna module, a power module and elements less related to the present invention, are all omitted from depiction herein. The following description will focus on the differences between the UMTS-FDD like system of the present invention and the UMTS-FDD Release 99 system.

The handheld device 2 comprises a processor 201 and a transceiver 203. The transceiver 203 is electronically connected to the processor 201. When the handheld device 2 communicates with the base station 4, the processor 201 generates an uplink signal 202. Afterwards, the transceiver 203 transmits the uplink signal 202 to the base station 4 and receives a downlink signal 204 from the base station 4 simultaneously. In the present invention, there may be acknowledgement (ACK) commands carried in the downlink signal 204 for informing the handheld device 2 of the decoding result of the DTCH information data and the DCCH information data in the transmitted radio data frame.

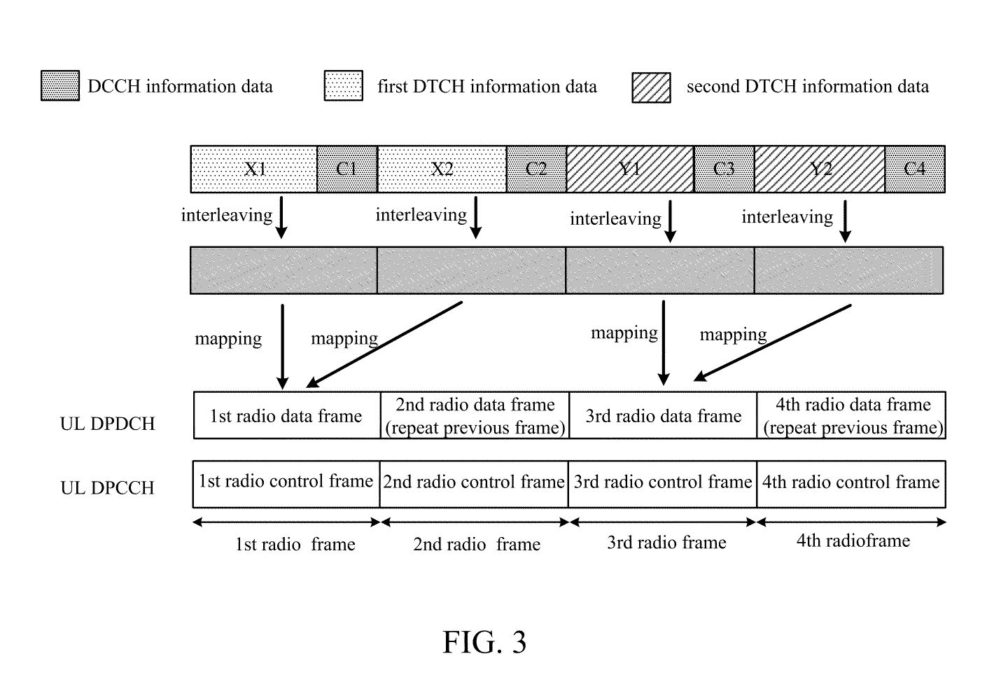

FIG. 3 depicts the transmission architecture in the normal mode of the UMTS-FDD like system of the present invention, in which there are an uplink dedicated physical data channel (UL DPDCH) and an uplink dedicated physical control channel (UL DPCCH) of the uplink signal within two transmission time intervals TTIs (i.e., four radio frames). The first dedicated traffic channel (DTCH) information data and the second DTCH information data are the processed user data generated by the processor 201, and the dedicated control channel (DCCH) information data is the processed signaling information data generated by the processor 201. Since how the DTCH information data and the DCCH information data are generated by the processor 201 are already known in the art, it will not be further described herein.

As shown in FIG. 3, the uplink signal comprises an UL DPDCH including a first radio data frame, a second radio data frame, a third radio data frame and a fourth radio data frame within two TTIs. In the present invention, the complete first DTCH information data (including the two segments X1, X2) and the first two segments C1, C2 of the DCCH information data are carried in the first radio data frame of the UL DPDCH. And, the second radio data frame of the UL DPDCH repeatedly carries the same data (i.e. the two segments X1, X2 and two segments C1, C2) as the first radio data frame. In other words, the first DTCH information data and the two segments C1, C2 of the DCCH information data are repeatedly carried in the first and second radio data frames. Therefore, the data carried in the first radio data frame of the UL DPDCH is entirely the same as that carried in the second radio data frame of the UL DPDCH.

Similarly, the complete second DTCH information data (including the two segments Y1, Y2) and the last two segments C3, C4 of the DCCH information data are carried in the third radio data frame of the UL DPDCH. Next, the fourth radio data fame of the UL DPDCH repeatedly carries the same data (i.e. the two segments Y1, Y2 and the two segments C3, C4) as the third radio data frame. In other words, the second DTCH information data and the last two segments C3, C4 of the DCCH information data are repeatedly carried in the third and fourth radio data frames; therefore, the data carried in the third radio data frame of the UL DPDCH is entirely the same as that carried in the fourth radio data frame of the UL DPDCH.

FIG. 4 is a schematic diagram of the base station 4. The base station 4 comprises a transceiver 401 and a processor 403. The transceiver 401 is configured to receive an uplink signal 202 from a handheld device 2. The processor 403 is electrically connected to the transceiver 401 and configured to process the uplink signal 202.

The second embodiment of the present invention is also depicted in FIGS. 2-4. As shown in FIG. 3, the uplink signal 202 further comprises an uplink dedicated physical control channel (UL DPCCH) including a first radio control frame, a second radio control frame, a third radio control frame and a fourth radio control frame within the two TTIs. In this embodiment, a first transport format combination indicator (TFCI) is carried in the first radio control frame to indicate a first transmission state which corresponds to the first and second radio data frames, and a second TFCI is carried in the third radio control frame to indicate a second transmission state which corresponds to the third and fourth radio data frames.

The base station 4 decodes the first TFCI firstly to know the states of the first DTCH information data and the DCCH information data. When the first transmission state indicates a mute state of the first DTCH information data and an off-state of the DCCH information data, there is no need for the base station 4 to decode the first DTCH information data and the DCCH information data. In this case, the base station 4 transmits a first ACK command carried in the downlink signal 204 after receiving the first radio data frame from the handheld device 2, and the first ACK command indicates a non-acknowledgement (NACK) response of the first DTCH information data and the DCCH information data. And, the handheld device 2 can consequently ignores the first ACK command.

Similarly, when the second transmission state indicates the mute state of the second DTCH information data and the off-state of the DCCH information data, the base station 4 does not decode the second DTCH information data and the DCCH information data, and may transmit a second ACK command that indicates the NACK response of the second DTCH information data and the DCCH information data to the handheld device 2. However, in other embodiments, the base station 4 may not transmit the ACK command that indicates the NACK response of the received DTCH information data and DCCH information data since the ACK command is useless for the handheld device 2 when the DTCH information data is in the mute state and the DCCH information is in the off-state. It is appreciated that the second TFCI indicates the same state of the DCCH information data as that indicated by the first TFCI since the DCCH information data is carried in the first to the fourth radio data frames.

More specifically, on the base station 4 side, the processor 403 decodes the first TFCI firstly to know the states of the first DTCH information data and the DCCH information data. When the first transmission state indicates the mute state of the first DTCH information data and the off-state of the DCCH information data, the processor 403 will not decode the first DTCH information data or the DCCH information data. Moreover, the processor 403 further decodes the second TFCI firstly to know the states of the second DTCH information data. When the second transmission state indicates the mute state of the second DTCH information data and the off-state of the DCCH information data, the processor 403 will not decode the second DTCH information data and the DCCH information data.

In the other case that the first transmission state indicates a non-mute state of the first DTCH information data and an off-state of the DCCH information data, the base station 4 decodes the first DTCH information data after receiving the first radio data frame from the handheld device 2. Then, the base station 4 transmits the first ACK command carried in the downlink signal 204 to the handheld device 2, and the first ACK command indicates whether the first DTCH information data has been decoded successfully by the base station 4. Specifically, the first ACK command indicating the NACK response informs the handheld device 2 that the first DTCH information data has not been successfully decoded yet. And the base station 4 shall decode the first DTCH information data again after receiving the second radio data frame. Conversely, the ACK command indicating the ACK response informs the handheld device 2 that the first DTCH information data has been decoded successfully.

It should be understood that the base station 4 in this embodiment decodes the first DTCH information data once the whole first radio data frame has been received. However, in other embodiments, the base station 4 may decode the first DTCH information data once parts of the first radio data frame has been received. In other words, the base station 4 of the present invention can early decode the first DTCH information data at or before the end of the first radio data frame.

After the transceiver 203 receives the first ACK command carried in the downlink signal 204 from the base station 4, the processor 201 can terminate transmitting the second radio data frame via the transceiver 203 when the ACK command indicates the ACK response. In detail, once the base station 4 has successfully decoded the first DTCH information data carried in the first radio data frame, the base station 4 will transmit the first ACK command by carrying it in the downlink signal 204 to indicate the ACK response so that the handheld device 2 can terminate transmitting the second radio data frame according to the ACK response. On the other hand, the processor 201 shall keep transmitting the second radio data frame via the transceiver 203 when the ACK command indicates the NACK response. Likewise, when the second transmission state indicates the non-mute state of the second DTCH information data and the off-state of the DCCH information data, the base station 4 decodes the second DTCH information data after receiving the third radio data frame from the handheld device 2. Then, the base station 4 transmits a second ACK command by carrying it in the downlink signal 204 to the handheld device 2. The transceiver 203 receives the second ACK command carried in the downlink signal 204 from the base station 4, and the processor 201 terminates transmitting the fourth radio data frame via the transceiver 203 when the second ACK command indicates the ACK response. On the other hand, the processor 201 shall keep transmitting the fourth radio data frame via the transceiver 203 when the second ACK command indicates the NACK response.

Likewise, it should be understood that the base station 4 in this embodiment decodes the second DTCH information data once the whole the third radio data frame has been received. However, in other embodiments, the base station 4 may decode the second DTCH information data once parts of the third radio data frame have been received. In other words, the base station 4 of the present invention can early decode the second DTCH information data at or before the end of the third radio data frame.

More specifically, on the base station 4 side, the processor 403 decodes the first DTCH information data and generates the first ACK command based on the decoding result of the first DTCH information data. Then, the transceiver 401 further transmits the first ACK command carried in the downlink signal 204 to the handheld device 2 after receiving the first radio data frame (i.e., the first ACK command may be carried in the first or second slot of the second radio frame). As aforementioned, the first ACK command indicates the NACK response if the first DTCH information data has not been decoded successfully yet and the base station 4 shall decode the first DTCH information data again after receiving the second radio data frame; conversely, the first ACK command indicates the ACK response if the first DTCH information data has been decoded successfully.

Afterwards, the processor 403 further decodes the second DTCH information data and generates the second ACK command according to the decoding result of the second DTCH information data. Then, the transceiver 401 further transmits the second ACK command carried in the downlink signal 204 to the handheld device 2 after receiving the third radio data frame (i.e., the second ACK command may be carried in the first or second slot of the fourth radio frame). As aforementioned, the second ACK command indicates the NACK response if the second DTCH information data has not been decoded successfully yet and the base station 4 shall decode the second DTCH information data again after receiving the forth radio data frame; conversely, the second ACK command indicates the ACK response if the second DTCH information data has been decoded successfully.

The third embodiment of the present invention is also depicted in FIGS. 2-4. Unlike the previous embodiments, the state of the DCCH information data in this embodiment is in an on-state, which means there is a signaling information data to be transmitted to the base station 4. In this embodiment, the base station 4 would not early decode the DTCH information data and the DCCH information data if the first transmission state indicates an on-state of the DCCH information data. In other words, the base station 4 would not decode the DCCH information data until the entire DCCH information data (i.e., the four segments C1, C2, C3 and C4 of the DCCH information data) has been received.

Specifically, when the first transmission state indicates the on-state of the DCCH information data, the processor 403 of the base station 4 generates the first ACK command indicating a NACK response. And, the transceiver 401 of the base station 4 transmits the first ACK command carried in the downlink signal 204 to the handheld device 2 after receiving the first radio data frame. And the base station 4 would decode the first DTCH information data after receiving the second radio data frame. On the other hand, the handheld device 2 may ignore the first ACK command from the base station 4 and continue to transmit the second radio data frame.

Since the second TFCI indicates the same state of the DCCH information data as that indicated by the first TFCI, the processor 403 of the base station 4 generates the second ACK command indicating the NACK response. And, the transceiver 401 of the base station 4 transmits the second ACK command carried in the downlink signal 204 to the handheld device 2 after receiving the third radio data frame. And the base station 4 would decode the second DTCH information data after receiving the forth radio data frame. On the other hand, the handheld device 2 may ignore the second ACK command from the base station 4 and continue to transmit the fourth radio data frame. In other words, the uplink radio data frame early termination would not be performed during the two TTIs.

It is noted that the first/second transmission state may also indicate either the mute state or the non-mute state of the first DTCH information data; however, no matter which kind of state of the first/second DTCH information data is, the base station 4 would not early decode the first/second DCCH information data as long as the first/second transmission state indicates the on-state of the DCCH information data.

The fourth embodiment of the present invention is also depicted in FIGS. 2-4. In this embodiment, when the first transmission state indicates the on-state of the DCCH information data, the base station 4 decodes the first DTCH information data and the DCCH information data firstly and then transmits the first ACK command carried in the downlink signal 204 to the handheld device 2 after receiving the first radio data frame from the handheld device 2. Thus, the transceiver 203 of the handheld device 2 will receive the first ACK command carried in the downlink signal 204 from the base station 4, and the processor 201 of the handheld device 2 terminates transmitting the second radio data frame via the transceiver 203 when the first ACK command indicates an ACK response. On the other hand, the processor 201 shall keep transmitting the second radio data frame via the transceiver 203 when the first ACK command indicates the NACK response.

Specifically, the first ACK command indicating the ACK response means that both the first DTCH information data and the DCCH information data have been decoded successfully. Otherwise, the first ACK command indicating the NACK response means that at least one of the first DTCH information data and the DCCH information data has not been decoded successfully yet and the base station 4 shall decode the first DTCH information data and/or the DCCH information data again after receiving the second radio data frame. In the case that the DCCH information data carried in the first and the second data frames has been decoded successfully based on the first two segments of the DCCH information data, the base station 4 will not decode the DCCH information data carried in the third and fourth data frames again; instead, the base station 4 will only decode the second DTCH information data consequently and then transmits the second ACK command carried in the downlink signal 204 to the handheld device 2 after receiving the third radio data frame from the handheld device 2. Therefore, the transceiver 203 of the handheld device 2 receives the second ACK command carried in the downlink signal 204 from the base station 4, and the processor 201 terminates transmitting the fourth radio data frame via the transceiver 203 when the second ACK command indicates the ACK response. On the other hand, the processor 201 shall keep transmitting the fourth radio data frame via the transceiver 203 when the second ACK command indicates the NACK response.

In the other situation, when the DCCH information data carried in the first and second data frames has not been decoded successfully based on the first two segments of the DCCH information data carried in the first radio data frame, the base station 4 will decodes the second DTCH information data and the DCCH information data carried in the third radio data frame and then transmits the second ACK command carried in the downlink signal 204 to the handheld device 2. The transceiver 203 of the handheld device 2 receives the second ACK command from the base station 4, and the processor 201 of the handheld device 2 terminates transmitting the fourth radio data frame via the transceiver 203 when the second ACK command indicates the ACK response. On the other hand, the processor 201 shall keep transmitting the fourth radio data frame via the transceiver 203 when the second ACK command indicates the NACK response.

On the base station 4 side, the processor 403 decodes the first DTCH information data and the DCCH information data carried in the first radio data frame and then generates the first ACK command according to a decoding result of the first DTCH information data and the DCCH information data. Then, the transceiver 401 transmits the first ACK command carried in the downlink signal 204 to the handheld device 2 after receiving the first radio frame. As aforementioned, the processor 403 generates the first ACK command indicating the ACK response only when both the first DTCH information data and the DCCH information data have been decoded successfully. Otherwise, the processor 403 generates the first ACK command indicating the NACK response and the base station 4 shall decode the first DTCH and/or DCCH information data again after receiving the second radio data frame.

Next, the processor 403 decodes the second DTCH information data when the DCCH information data carried in the first and the second data frames has been decoded successfully based on the first two segments C1, C2 of the DCCH information data. In addition, the processor 403 generates the second ACK command according to the decoding result of the second DTCH information data, and then the transceiver 401 transmits the second ACK command carried in the downlink signal 204 to the handheld device 2 after receiving the third radio data frame. Conversely, if the DCCH information data carried in the first and the second data frames has not been decoded successfully based on the two segments C1, C2 of the DCCH information data, the processor 403 then decodes the second DTCH information data and the DCCH information data carried in the third radio data frame and generates the second ACK command according to the decoding result of the second DTCH information data and the DCCH information data.

In other words, the base station 4 in this embodiment early decodes the first DTCH information data and the DCCH information data after receiving the first radio data frame from the handheld device 2. In addition, the base station 4 also early decodes the second DTCH information data (and the DCCH information data if the DCCH information data has not been decoded successfully according to the first two segments of the DCCH information data) after receiving the third radio data frame from the handheld device 2.

Please also refer to FIGS. 2-4 for the fifth embodiment of the present invention. Compared to the fourth embodiment, the first ACK command in this embodiment always indicates the NACK response. In other words, the base station 4 in this embodiment would not early decode the first DTCH information data and the DCCH information data based on the first two segments of the DCCH information data when the first transmission state indicates an on-state of the DCCH information data. Instead, the base station 4 in this embodiment only early decodes the second DTCH information data and the DCCH information data carried in the third radio data frame since it is easier for the base station 4 to decode the DCCH information data successfully when the base station 4 receives enough DCCH information data (i.e., both the first two segments C1, C2 and the last two segments C3, C4 of the DCCH information data has been received by the base station 4).

Specifically, the transceiver 401 of the base station 4 transmits the first ACK command carried in the downlink signal 204 to the handheld device 2 after receiving the first radio data frame from the handheld device 2. Since the first ACK command always indicates the NACK response, the handheld device 2 would not perform the early termination on the second radio data frame. Then the processor 403 of the base station 4 decodes the first DTCH information data at the end of the second radio data frame. Similarly, the present invention is not intended to limit the time point at which the processor 403 decodes the first DTCH information data. Thus, in other embodiments, the processor 403 of the base station 4 may early decode first DTCH information data at the end of the first radio data frame.

Afterwards, the processor 403 decodes the second DTCH information data and the DCCH information data at the end of the third radio data frame and generates the second ACK command according to the decoding result of the second DTCH information data and the DCCH information. Likewise, the second ACK command indicates the ACK response if both the second DTCH information data and the DCCH information data have been decoded successfully. Otherwise, the second ACK command indicates the NACK response. It is noted that the processor 403 in this embodiment decodes the second DTCH information data and the DCCH information data at the end of the third radio data frame. However, in other embodiments, the processor 403 may early decode the second DTCH information data and the DCCH information data once parts of the third radio data frame has been received.

Then, the transceiver 401 transmits the second ACK command carried in the downlink signal 204 to the handheld device 2. As a result, after the transceiver 203 of the handheld device 2 receives the second ACK command from the base station 4, the processor 201 of the handheld device 2 terminates transmitting the fourth radio data frame via the transceiver 203 when the second ACK command indicates the ACK response. On the other hand, the processor 201 shall keep transmitting the fourth radio data frame via the transceiver 203 when the second ACK command indicates the NACK response. And the base station 4 shall decode the second DTCH and/or DCCH information data again after receiving the fourth radio data frame.

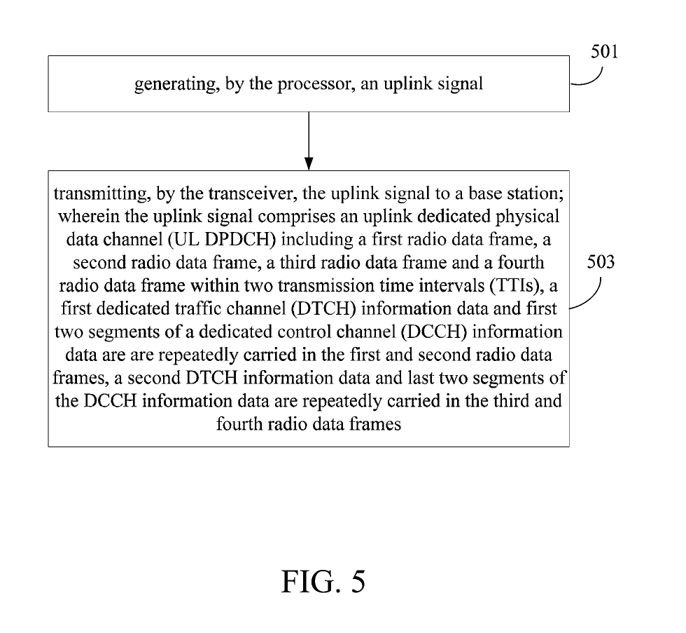

The sixth embodiment of the present invention is a transmission control method, a flow chart of which is shown in FIG. 5. The transmission control method is for use in a handheld device, e.g., the handheld device 2 of the first to fifth embodiments. The handheld device comprises a processor and a transceiver. The transceiver is electrically connected to the processor.

First, step 501 is executed by the processor to generate an uplink signal. Afterwards, step 503 is executed by the transceiver to transmit the uplink signal to a base station. The uplink signal comprises an uplink dedicated physical data channel (UL DPDCH) including a first radio data frame, a second radio data frame, a third radio data frame and a fourth radio data frame within two transmission time intervals (TTIs). A first dedicated traffic channel (DTCH) information data and first two segments of a dedicated control channel (DCCH) information data are repeatedly carried in the first and second radio data frames, and a second DTCH information data and a last two segments of the DCCH information data are repeatedly carried in the third and fourth radio data frames.

In other embodiments, the uplink signal further comprises an uplink dedicated physical control channel (UL DPCCH) including a first radio control frame, a second radio control frame, a third radio control frame and a fourth radio control frame within the two TTIs. A first transport format combination indicator (TFCI) is carried in the first radio control frame to indicate a first transmission state corresponding to the first and second radio data frames, and a second TFCI is carried in the third radio control frame to indicate a second transmission state corresponding to the third and fourth radio data frames.

When the first transmission state indicates a non-mute state of the first DTCH information data and an off-state of the DCCH information data, the base station decodes the first DTCH information data and then transmits a first acknowledgement (ACK) command carried in a downlink signal to the handheld device after receiving the first radio data frame. Therefore, the transmission control method further comprises the following steps of: receiving, by the transceiver, the first ACK command carried in the downlink signal from the base station; and terminating, by the processor, transmitting the second radio data frame via the transceiver when the first ACK command indicates an ACK response.

Likewise, when the second transmission state indicates a non-mute state of the second DTCH information data and the off-state of the DCCH data, the base station decodes the second DTCH information data and then transmits a second ACK command carried in the downlink signal to the handheld device after receiving the third radio data frame. As a result, the transmission control method further comprises the following steps: receiving, by the transceiver, the second ACK command carried in the downlink signal from the base station; and terminating, by the processor, transmitting the fourth radio data frame via the transceiver when the ACK command indicates the ACK response.

In another embodiment, when the first transmission state indicates an on-state of the DCCH information data, and the base station always transmits the first ACK command indicating a negative-acknowledgement (NACK) response carried in the downlink signal to the handheld device after receiving the first radio data frame and always transmits the second ACK command indicating the NACK response carried in the downlink signal after receiving third first radio data frame.

Moreover, in other embodiments, when the first transmission state indicates the on-state of the DCCH, the base station decodes the first DTCH information data and the DCCH information data carried in the first radio frame and then transmits the first ACK command carried in the downlink signal to the handheld device, and the transmission control method further comprises the following steps: receiving, by the transceiver, the first ACK command carried in the downlink signal from the base station; and terminating, by the processor, transmitting the second radio data frame via the transceiver when the first ACK command indicates an ACK response.

In the situation that the DCCH information data carried in the first and second data frames has been decoded successfully based on the first two segments of the DCCH information data, the base station further decodes the second DTCH information data and then transmits a second ACK command carried in the downlink signal to the handheld device after receiving the third radio data frame, and the transmission control method further comprises the following steps of receiving, by the transceiver, the second ACK command carried in the downlink signal from the base station; and terminating, by the processor, transmitting the fourth radio data frame via the transceiver when the second ACK command indicates the ACK response.

Conversely, when the DCCH information data carried in the first and second data frames has not been decoded successfully based on the first two segments of the DCCH information data, the base station further decodes the second DTCH information data and the DCCH information data and then transmits the second ACK command carried in the downlink signal to the handheld device, and the transmission control method further comprises the following steps: receiving, by the transceiver, the second ACK command carried in downlink signal from the base station; and terminating, by the processor, transmitting the fourth radio data frame via the transceiver when the second ACK command indicates the ACK response.

In other embodiments, the base station would not early decode the DCCH information data based on the first two segments of the DCCH information data if the first transmission state indicates the on-state of the DCCH information data, and the first ACK command always indicates the NACK response. Specifically, when the first transmission state indicates the on-state of the DCCH data, the base station transmits the first ACK command carried in the downlink signal after receiving the first radio data frame and may decode the first DTCH information data after receiving the second radio data frame. Afterwards, the base station early decodes the second DTCH information data and the DCCH information data after receiving the third radio data frame and then transmits the second ACK command carried in the downlink signal to the handheld device. In this case, the transmission control method further comprises the following steps: receiving, by the transceiver, the second ACK command carried in the downlink signal from the base station; and terminating, by the processor, transmitting the fourth radio data frame via the transceiver when the second ACK command indicates the ACK response.

In addition to the aforesaid steps, the transmission control method of the present invention can also execute all the operations and corresponding functions set forth in the first to fifth embodiment. How to execute these operations and functions will be readily appreciated by those of ordinary skill in the art based on the explanation of the first to fifth embodiments, and thus, will not be further described herein.

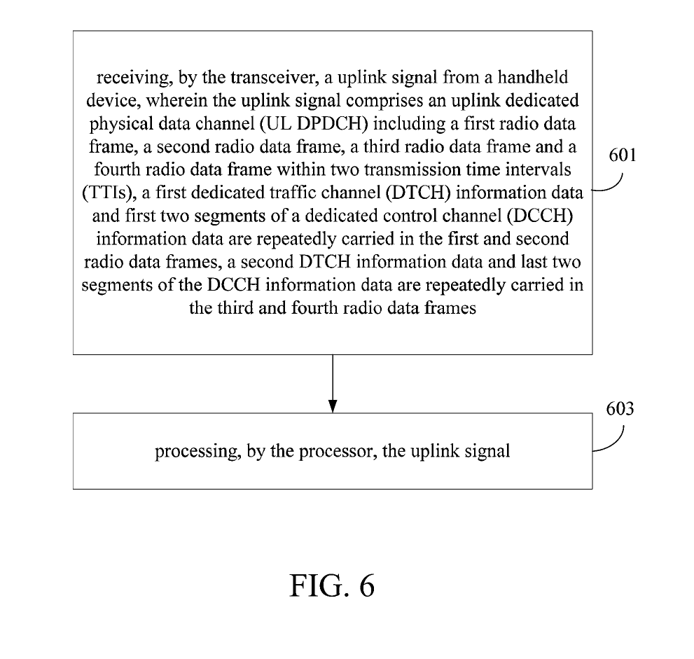

The seventh embodiment of the present invention is a transmission control method, a flowchart of which is shown in FIG. 6. The transmission control method is for use in a base station, e.g., the base station 4 of the first to fifth embodiments. The base station comprises a processor and a transceiver. The transceiver is electrically connected to the processor. First, step 601 is executed by the transceiver to receive an uplink signal from a handheld device. The uplink signal comprises an uplink dedicated physical data channel (UL DPDCH) including a first radio data frame, a second radio data frame, a third radio data frame and a fourth radio data frame within two transmission time intervals (TTIs). A first dedicated traffic channel (DTCH) information data and first two segments of a dedicated control channel (DCCH) information data are repeatedly carried in the first and second radio data frames, and a second DTCH information data and last two segments of the DCCH information data are repeatedly carried in the third and fourth radio data frames. Afterwards, step 603 is executed by the processor to process the uplink signal.

In other embodiments, the uplink signal further comprises an uplink dedicated physical control channel (UL DPCCH) including a first radio control frame, a second radio control frame, a third radio control frame and a fourth radio control frame within the two TTIs. A first transport format combination indicator (TFCI) is carried in the first radio control frame to indicate a first transmission state corresponding to the first and second radio data frames, and a second TFCI is carried in the third radio control frame to indicate a second transmission state corresponding to the third and fourth radio data frames.

The transmission control method further comprises the following steps of: decoding, by the processor, the first DTCH information data when the first transmission state indicates a non-mute state of the first DTCH information and an off-state of the DCCH information data; generating, by the processor, a first acknowledgement (ACK) command according to an early decoding result of the first DTCH information data; and transmitting, by the transceiver, the ACK command carried in the downlink signal to the handheld device after receiving the first radio data frame.

Moreover, the transmission control method further comprises the following steps of decoding, by the processor, the second DTCH information data when the second transmission state indicates a non-mute state of the second DTCH information data and the off-state of the DCCH information data; generating, by the processor, a second ACK command according to an early decoding result of the second DTCH information data; and transmitting, by the transceiver, the second ACK command carried in the downlink signal to the handheld device after receiving the third radio data frame.

In another embodiment, when the first transmission state indicates the on-state of the DCCH information data, the base station would not early decode the first and second DTCH information data and the DCCH information data, and the first ACK command and the second ACK command always indicates a negative-acknowledgement (NACK) response. The transmission control method further comprises the following steps of: generating, by the processor, the first ACK command when the first transmission state indicates the on-state of the DCCH information data; transmitting, by the transceiver, the first ACK command carried in the downlink signal to the handheld device after receiving the first radio data frame; generating, by the processor, the second ACK command; transmitting, by the transceiver, the second ACK command carried in the downlink signal to the handheld device after receiving the third radio data frame.

In other embodiments, when the first transmission state indicates the on-state of the DCCH information data, the base station would early decode the first and second DTCH information data and the DCCH information data based on the first two segments of the DCCH information data. The transmission control method further comprises the following steps of: decoding, by the processor, the first DTCH information data and the DCCH information data when the first transmission state indicates an on-state of the DCCH information data; generating, by the processor, the first ACK command according to the early decoding result of the first DTCH information data and the DCCH information data; and transmitting, by the transceiver, the first ACK command carried in the downlink signal to the handheld device after receiving the first radio data frame.

When the DCCH information data carried in the first and the second data frames has been decoded successfully based on the first two segments of the DCCH information data, the transmission control method further comprises the following steps: decoding, by the processor, the second DTCH information data; generating, by the processor, the second ACK command according to an early decoding result of the second DTCH information data; and transmitting, by the transceiver, the second ACK command carried in the downlink signal to the handheld device after receiving the third radio data frame.

Conversely, when the DCCH information data carried in the first and the second data frames has not been decoded successfully based on the first two segments of the DCCH information data, the transmission control method further comprises the following steps: decoding, by the processor, the second DTCH information data and the DCCH information data; generating, by the processor, the second ACK command according to an early decoding result of the second DTCH information data and the DCCH information data; and transmitting, by the transceiver, the second ACK command carried in the downlink signal to the handheld device after receiving the third radio data frame.

Moreover, in other embodiments, the base station would not early decode the DCCH information data based on the first two segments of the DCCH information data when the first transmission state indicates the on-state of the DCCH information data, and the first ACK command always indicates the NACK response. The transmission control method further comprises the following steps: generating, by the processor, the first ACK command indicating the NACK response when the first transmission state indicates the on-state of the DCCH information data; transmitting, by the transceiver, the first ACK command carried in the downlink signal to the handheld device after receiving the first radio data frame; decoding, by the processor, the second DTCH information data and the DCCH information data; generating, by the processor, the second ACK command according to a decoding result of the second DTCH information data and the DCCH information; and transmitting, by the transceiver, the second ACK command carried in the downlink signal to the handheld device after receiving the third radio data frame.

In addition to the aforesaid steps, the transmission control method of the present invention can also execute all the operations and corresponding functions set forth in the first to fifth embodiment. How to execute these operations and functions will be readily appreciated by those of ordinary skill in the art based on the explanation of the first to fifth embodiments, and thus, will not be further described herein.

According to the above descriptions, the transmission architecture of the present invention enables the base station to early decode the DTCH information data and the DCCH information in the uplink radio data frames and to transmit the ACK command to the handheld device in time so as to achieve the uplink radio data frame early termination (FET) by terminating the transmission of the uplink radio data frame on the handheld device. Accordingly, the transmission power of the handheld device can be saved, the interference among the uplink signals can be reduced and the uplink capacity for UMTS FDD system can be greatly enhanced.

The above disclosure is related to the detailed technical contents and inventive features thereof. People skilled in this field may proceed with a variety of modifications and replacements based on the disclosures and suggestions of the invention as described without departing from the characteristics thereof. Nevertheless, although such modifications and replacements are not fully disclosed in the above descriptions, they have substantially been covered in the following claims as appended.

What is claimed is:

1. A handheld device comprising:
a processor, being configured to generate an uplink signal; and
a transceiver, being electrically connected to the processor and configured to transmit the uplink signal to a base station;
wherein the uplink signal comprises an uplink dedicated physical data channel (UL DPDCH) including a first radio data frame, a second radio data frame, a third radio data frame and a fourth radio data frame within two transmission time intervals (TTIs), a first dedicated traffic channel (DTCH) information data and first two segments of a dedicated control channel (DCCH) information data are repeatedly carried in the first and second radio data frames, a second DTCH information data and last two segments of the dedicated control channel (DCCH) information data are repeatedly carried in the third and fourth radio data frames.

2. The handheld device as claimed in claim 1, wherein the uplink signal further comprises an uplink dedicated physical control channel (UL DPCCH) including a first radio control frame, a second radio control frame, a third radio control frame and a fourth radio control frame within the two TTIs, a first transport format combination indicator (TFCI) is carried in the first radio control frame to indicate a first transmission state corresponding to the first and second radio data frames, and a second TFCI is carried in the third radio control frame to indicate a second transmission state corresponding to the third and fourth radio data frames.

3. The handheld device as claimed in claim 2, wherein when the first transmission state indicates a non-mute state of the first DTCH information data and an off-state of the DCCH information data, the transceiver further receives a first ACK command from the base station, and the processor terminates transmitting the second radio data frame via the transceiver when the first ACK command indicates an ACK response.

4. The handheld device as claimed in claim 3, wherein when the second transmission state indicates a non-mute state of the second DTCH information data and the off-state of the DCCH information data, the transceiver further receives a second ACK command from the base station, and the processor terminates transmitting the fourth radio data frame via the transceiver when the ACK command indicates the ACK response.

5. The handheld device as claimed in claim 2, wherein when the first transmission state indicates an on-state of the DCCH information data, the transceiver receives a first ACK command and a second ACK command from the base station, and the first ACK command and the second ACK command indicate a negative-acknowledgement (NACK) response.

6. The handheld device as claimed in claim 2, wherein when the first transmission state indicates an on-state of the DCCH information data, the transceiver further receives a first ACK command from the base station, and the processor terminates transmitting the second radio data frame via the transceiver when the first ACK command indicates an ACK response.

7. The handheld device as claimed in claim 6, wherein the transceiver further receives a second ACK command from the base station, and the processor terminates transmitting the fourth radio data frame via the transceiver when the second ACK command indicates the ACK response.

8. The handheld device as claimed in claim 2, wherein when the first transmission state indicates an on-state of the DCCH data, the transceiver receives a first ACK command which indicates a NACK response and a second ACK command from the base station, and the processor terminates transmitting the fourth radio data frame via the transceiver when the second ACK command indicates the ACK response.

9. A transmission control method for use in a handheld device, the handheld device comprising a processor and a transceiver, the transceiver being electrically connected to the processor, the transmission control method comprising the following steps:
generating, by the processor, an uplink signal; and
transmitting, by the transceiver, the uplink signal to a base station;
wherein the uplink signal comprises an uplink dedicated physical data channel (UL DPDCH) including a first radio data frame, a second radio data frame, a third radio data frame and a fourth radio data frame within two transmission time intervals (TTIs), a first dedicated traffic channel (DTCH) information data and first two segments of a dedicated control channel (DCCH) information data are repeatedly carried in the first and second radio data frames, a second DTCH information data and last two segments of the DCCH information data are repeatedly carried in the third and fourth radio data frames.

10. A base station comprising:
a transceiver, being configured to receive a uplink signal from a handheld device, wherein the uplink signal comprises an uplink dedicated physical data channel (UL DPDCH) including a first radio data frame, a second radio data frame, a third radio data frame and a fourth radio data frame within two transmission time intervals (TTIs), a first dedicated traffic channel (DTCH) information data and first two segments of a dedicated control channel (DCCH) information data are repeatedly carried in the first and second radio data frames, a second DTCH information data and last two segments of the DCCH information data are repeatedly carried in the third and fourth radio data frames; and
a processor, being electrically connected to the transceiver and configured to process the uplink signal.

11. The base station as claimed in claim 10, wherein the uplink signal further comprises an uplink dedicated physical control channel (UL DPCCH) including a first radio control frame, a second radio control frame, a third radio control frame and a fourth radio control frame within the two TTIs, a first transport format combination indicator (TFCI) is carried in the first radio control frame to indicate a first transmission state corresponding to the first and second radio data frames, and a second TFCI is carried in the third radio control frame to indicate a second transmission state corresponding to the third and fourth radio data frames.

12. The base station as claimed in claim 11, wherein when the first transmission state indicates a non-mute state of the first DTCH information and an off-state of the DCCH information data, the processor further decodes the first DTCH information data and generates a first acknowledgement (ACK) command according to a decoding result of the first DTCH information data, and the transceiver further transmits the first ACK command carried in a downlink signal to the handheld device after receiving the first radio data frame.

13. The base station as claimed in claim 12, wherein when the second transmission state indicates a non-mute state of the second DTCH information data and the off-state of the DCCH information data, the processor further decodes the second DTCH information data and generates a second ACK command according to a decoding result of the second DTCH information data, and the transceiver further transmits the second ACK command carried in the downlink signal to the handheld device after receiving the third radio data frame.

14. The base station as claimed in claim 11, wherein when the first transmission state indicates an on-state of the DCCH information data, the processor further decodes the first DTCH information data and generates a first ACK command indicating a negative-acknowledgement (NACK) response, and the transceiver further transmits the first ACK command carried in a downlink signal to the handheld device after receiving the first radio data frame; and wherein the processor further decodes the second DTCH information data and the DCCH information data and generates a second ACK command indicating the NACK response, and the transceiver further transmits the second ACK command carried in the downlink signal to the handheld device after receiving the third radio data frame.

15. The base station as claimed in claim 11, wherein when the first transmission state indicates an on-state of the DCCH information data, the processor further decodes the first DTCH information data and the DCCH information data and generates a first ACK command according to a decoding result of the first DTCH information data and the DCCH information data, and the transceiver further transmits the first ACK command carried in a downlink signal to the handheld device after receiving the first radio data frame.

16. The base station as claimed in claim 15, wherein when the DCCH information data carried in the first and the second data frames has been decoded successfully based on the first two segments of the DCCH information data, the processor further decodes the second DTCH information data and generates a second ACK command according to a decoding result of the second DTCH information data, and the transceiver further transmits the second ACK command carried in the downlink signal to the handheld device after receiving the third radio data frame.

17. The base station as claimed in claim 15, wherein when the DCCH information data carried in the first and the second data frames has not been decoded successfully based on the first two segments of the DCCH information data, the processor further decodes the second DTCH information data and the DCCH information data and generates a second ACK command according to a decoding result of the second DTCH information data and the DCCH information data, and the transceiver further transmits the second ACK command to the handheld device carried in the downlink signal after receiving the third radio data frame.

18. The base station as claimed in claim 11, wherein when the first transmission state indicates an on-state of the DCCH information data, the processor further decodes the first DTCH information data and generates a first ACK command indicating a NACK response, and the transceiver further transmits the first ACK command carried in the downlink signal to the handheld device after receiving the first radio data frame; wherein the processor further decodes the second DTCH information data and the DCCH information data after receiving the third radio data frame and then generates a second ACK command according to a decoding result of the second DTCH information data and the DCCH information, and the transceiver further transmits the second ACK command carried in the downlink signal to the handheld device after receiving the third radio data frame.

19. A transmission control method for use in a base station, the base station comprising a processor and a transceiver, the transceiver being electrically connected to the processor, the transmission control method comprising the following steps:
receiving, by the transceiver, a uplink signal from a handheld device, wherein the uplink signal comprises an uplink dedicated physical data channel (UL DPDCH) including a first radio data frame, a second radio data frame, a third radio data frame and a fourth radio data frame within two transmission time intervals (TTIs), a first dedicated traffic channel (DTCH) information data and first two segments of a dedicated control channel (DCCH) information data are repeatedly carried in the first and second radio data frames, a second DTCH information data and last two segments of the DCCH information data are repeatedly carried in the third and fourth radio data frames; and
processing, by the processor, the uplink signal.
